(19) United States
(12) Patent Application Publication
(10) Pub. No.: US 2025/0162261 A1
(43) Pub. Date: May 22, 2025

(54) METHOD AND APPARATUS FOR 3D PRINTER, 3D PRINTER, AND STORAGE MEDIUM

(71) Applicant: SHANGHAI LUNKUO TECHNOLOGY CO., LTD., SHANGHAI (CN)

(72) Inventor: Yifan WU, SHANGHAI (CN)

(73) Assignee: SHANGHAI LUNKUO TECHNOLOGY CO., LTD., SHANGHAI (CN)

(21) Appl. No.: 19/035,815

(22) Filed: Jan. 23, 2025

Related U.S. Application Data
(63) Continuation of application No. PCT/CN2023/093461, filed on May 11, 2023.

(30) Foreign Application Priority Data
May 13, 2022 (CN) 202210523049.X

(51) Int. Cl. B29C 64/393; B29C 64/171; B29C 64/386; B33Y 50/00; B33Y 50/02

(52) U.S. Cl. CPC B29C 64/393; B29C 64/171; B29C 64/386; B33Y 50/00; B33Y 50/02

(57) ABSTRACT

A method comprises: acquiring a three-dimensional model file defining multiple models in a batch printing task; establishing a one-to-one correspondence between respective model identifiers of the multiple models and multiple first pixel regions in a first image, wherein the first image is used to display respective graphical representations of the multiple models in a user interface, and each first pixel region is used to display a corresponding graphical representation in the respective graphical representations of the multiple models; and generating, based on the three-dimensional model file, one set of control codes comprising multiple code segments, each code segment comprising control codes for printing a corresponding model in the multiple models and a model identifier of the corresponding model, wherein the one set of control codes is executable by a processor of the 3D printer to enable the 3D printer to execute a printing strategy.

### CROSS-REFERENCE TO RELATED APPLICATION

This application is a continuation of International Patent Application No. PCT/CN2023/093461, filed on May 11, 2023, which claims priority to Chinese Patent Application No. 202210523049.X, filed on May 13, 2022. The disclosures of the aforementioned applications are hereby incorporated by reference in their entireties.

### TECHNICAL FIELD

The present disclosure relates to the technical field of three-dimensional (3D) printing, and in particular to a method and apparatus for a 3D printer, a 3D printer, a 3D printing system, a computer-readable storage medium, and a computer program product.

### BACKGROUND

3D printing technology, also known as additive manufacturing, is a technique for constructing objects by layer-by-layer printing using bondable materials based on digital model files. 3D printing is typically achieved by using a 3D printer. A 3D printer, also known as a three-dimensional printer or an additive manufacturing device, is a process equipment for rapid prototyping. A typical 3D printing technology is Fused Deposition Modeling (FDM). The working principle of FDM involves a hot melt nozzle moving in a horizontal plane under computer control, based on the cross-sectional profile information of a product part. Thermoplastic filament material is fed to the hot melt nozzle by a feeding mechanism, and the melted material is extruded from the nozzle and deposited onto the hot bed, where it quickly cools down to form a thin layer contour. After one layer of a cross section is formed, the hot bed moves a certain distance in the vertical direction, followed by the cladding of the next layer. This cycle repeats until the three-dimensional product part is ultimately formed.

The methods described in this section are not necessarily methods that have been previously conceived or pursued. Unless otherwise indicated, it should not be assumed that any of the methods described in this section qualify as prior art merely by virtue of their inclusion in this section. Similarly, unless otherwise indicated, the problems mentioned in this section should not be considered as having been acknowledged in any prior art.

### SUMMARY

The present disclosure provides a 3D printer, a method and apparatus for a 3D printer, a 3D printing system, a computer-readable storage medium, and a computer program product.

According to some aspects of the present disclosure, a 3D printer is provided. The 3D printer comprises a processor and a memory storing one set of control codes. The one set of control codes is generated based on a three-dimensional model file defining multiple models in a batch printing task, and there is a one-to-one correspondence between respective model identifiers of the multiple models and multiple first pixel regions in a first image. The first image is used to display respective graphical representations of the multiple models in a user interface, and each first pixel region is used to display a corresponding graphical representation in the respective graphical representations of the multiple models. The one set of control codes comprises multiple code segments, each code segment comprising control codes for printing a corresponding model in the multiple models and a model identifier of the corresponding model. The one set of control codes is executable by the processor of the 3D printer to enable the 3D printer to execute a printing strategy, the printing strategy comprising: skipping, in response to acquiring a control instruction to skip printing a target model in the multiple models, execution of control codes within at least one code segment among the multiple code segments, the control instruction comprising a model identifier of the target model, and the at least one code segment comprising the model identifier of the target model, wherein the control instruction is generated based on a selection operation of a user regarding a graphical representation of the target model on the first image through the user interface and the one-to-one correspondence.

According to some aspects of the present disclosure, a method for a 3D printer is provided. The method comprises: acquiring a three-dimensional model file defining multiple models in a batch printing task; establishing a one-to-one correspondence between respective model identifiers of the multiple models and multiple first pixel regions in a first image, wherein the first image is used to display respective graphical representations of the multiple models in a user interface, and each first pixel region is used to display a corresponding graphical representation in the respective graphical representations of the multiple models; and generating, based on the three-dimensional model file, one set of control codes comprising multiple code segments, each code segment comprising control codes for printing a corresponding model in the multiple models and a model identifier of the corresponding model, wherein the one set of control codes is executable by a processor of the 3D printer to enable the 3D printer to execute a printing strategy. The printing strategy comprises: skipping, in response to acquiring a control instruction to skip printing a target model in the multiple models, execution of control codes within at least one code segment among the multiple code segments, the control instruction comprising a model identifier of the target model, and the at least one code segment comprising the model identifier of the target model, wherein the control instruction is generated based on a selection operation of a user regarding a graphical representation of the target model on the first image through the user interface and the one-to-one correspondence.

According to another aspect of the present disclosure, an apparatus for a 3D printer is provided. The apparatus comprises: a model acquisition unit, configured to acquire a three-dimensional model file defining multiple models in a batch printing task; a first image generation unit, configured to establish a one-to-one correspondence between respective model identifiers of the multiple models and multiple first pixel regions in a first image, wherein the first image is used to display respective graphical representations of the multiple models in a user interface, and each first pixel region is used to display a corresponding graphical representation in the respective graphical representations of the multiple models; and a control code generation unit, configured to generate, based on the three-dimensional model file, one set of control codes comprising multiple code segments, each code segment comprising control codes for printing a corresponding model in the multiple models and a model identifier of the corresponding model, wherein the one set of control codes is executable by a processor of the 3D printer to enable the 3D printer to execute a printing strategy. The printing strategy comprises: skipping, in response to acquiring a control instruction to skip printing a target model in the multiple models, execution of control codes within at least one code segment among the multiple code segments, the control instruction comprising a model identifier of the target model, and the at least one code segment comprising the model identifier of the target model, wherein the control instruction is generated based on a selection operation of a user regarding a graphical representation of the target model on the first image through the user interface and the one-to-one correspondence.

According to yet another aspect of the present disclosure, a 3D printer is further provided, comprising a processor, and a memory storing one set of control codes generated using the method described above, wherein the one set of control codes is executable by the processor of the 3D printer to enable the 3D printer to execute the printing strategy.

According to yet another aspect of the present disclosure, a 3D printing system is further provided, comprising a 3D printer, and 3D printing slicing software configured to perform the method described above.

According to yet another aspect of the present disclosure, a non-transitory computer-readable storage medium storing computer instructions is further provided, wherein the computer instructions are used to cause the computer to perform the method described above.

According to yet another aspect of the present disclosure, a computer program product comprising a computer program is further provided, wherein the computer program, when run by a processor, causes the processor to implement the method described above.

According to the method of the embodiments of the present disclosure, the 3D printer can promptly skip the printing operations for a designated model. This can save printing material on one hand, and on the other hand, it can reduce or prevent the excess extruded printing material from smearing onto other printing parts on the hot bed, thus protecting the appearance and shape of other printed parts.

### BRIEF DESCRIPTION OF THE DRAWINGS

FIG. 1 shows a structural schematic diagram of a 3D printer according to the embodiments of the present disclosure;

FIG. 2 shows a flowchart of a method for a 3D printer according to the embodiments of the present disclosure;

FIG. 3 shows a schematic diagram of a first image in the method for a 3D printer according to the embodiments of the present disclosure;

FIG. 4 shows a schematic diagram of a first image and a second image in the method for a 3D printer according to the embodiments of the present disclosure;

FIG. 5 shows a schematic block diagram of an apparatus for a 3D printer according to the embodiments of the present disclosure; and

FIG. 6 shows a schematic block diagram of a computer device according to the embodiments of the present disclosure.

### DETAILED DESCRIPTION

It should be understood that in this specification, terms such as “center”, “longitudinal”, “transverse”, “length”, “width”, “thickness”, “up”, “down”, “front”, “rear”, “left”, “right”, “vertical”, “horizontal”, “top”, “bottom”, “inner”, “outer”, “clockwise”, “counterclockwise”, “axial”, “radial”, “circumferential” and other directional or positional or dimensional indications are based on the orientations or position or dimension shown in the accompanying drawings. These terms are used merely to facilitate the description. These terms do not suggest or imply that the apparatus or elements indicated must have specific orientations, or be constructed or operated in specific orientations, and therefore should not be construed as limiting the protection scope of the present application.

In addition, the terms “first”, “second” and “third” are only for the purpose of description, and may not be construed as indicating or implying the relative importance or implicitly indicating the number of technical features denoted. Thus, features defined by “first”, “second” and “third” may explicitly or implicitly include one or more of the features. In the description of the present application, “plurality/multiple” refers to two or more, unless otherwise explicitly and specifically defined.

In the present application, unless otherwise clearly specified and defined, the terms “mount”, “link”, “connect”, “fasten” and the like should be comprehended in their broad sense. For example, “connect” may be “fixedly connect”, “detachably connect” or “integrally connected as one”; “mechanically connect”, “electrically connect” or “communicate”; “directly interconnect” or “indirectly interconnect through an intermediate”; or “the communication between the interiors of two elements” or “the interaction between two elements”. For those of ordinary skill in the art, the specific meanings of the aforementioned terms in the present application can be interpreted according to specific conditions.

Unless otherwise explicitly stated or defined herein, the recitation of a first feature “on” or “under” a second feature may include the recitation of the first and second features being in direct contact, and may also include the recitation that the first and second features are not in direct contact, but are in contact via another feature between them. Moreover, a first feature “on”, “above” and “over” a second feature includes a first feature being directly above and obliquely above a second feature, or simply indicates that the horizontal height of a first feature is higher than that of a second feature. A first feature “beneath”, “under” and “below” a second feature includes a first feature being directly under and obliquely under a second feature, or simply indicates that the horizontal height of a first feature is smaller than that of a second feature.

Before describing in detail various embodiments of the present disclosure, the basic working principle of 3D printing is first briefly introduced. Before conducting 3D printing operations, the 3D model to be printed may be sliced using slicing software, thus converting the model into G-code. Subsequently, the G-code is sent to the 3D printer to enable the 3D printer to carry out the printing operations based on the printing strategy defined in the G-code. In scenarios involving the printing of multiple models, the printing strategy of the 3D printer primarily falls into two categories: The first is layer-by-layer printing, where the first layers of the multiple models are printed respectively on the hot bed, then the second layers of the multiple models are printed respectively; this process continues until the last layer of each model among the multiple models is printed individually. The second is piece-by-piece printing, where one complete model is printed before proceeding to print another complete model.

However, in scenarios involving the printing of multiple models, certain factors may lead to the failure of printing one or more models during the printing process. For example, a printed part may not adhere properly to the hot bed, resulting in the detachment of the part during the printing process. For another example, in some scenarios where support portions need to be printed for parts, errors in printing the support portions during an actual printing process may lead to the parts being printed in mid-air or experiencing wobbling during the printing process. For yet another example, during the printing process, certain areas of a part may curl up, causing the printer nozzle to collide with the part and resulting in a printing failure of the part.

When a part fails to be printed, the 3D printer will continue printing according to the established printing strategy in the G-code. That is, the printing nozzle of the 3D printer may continue extruding printing material above the failed part. This, on the one hand, wastes printing time and printing material. On the other hand, because the part underneath the extruded material has collapsed or shifted, the extruded material may hang from the printer's extrusion head. As the printing head moves, the extruded material may smear onto the next part, thus compromising the appearance and shape of the next part.

In the 3D printing system in the related art, users facing such problems can only wait for the 3D printer to complete its established printing strategy before collecting unsmeared printed parts from the hot bed, or they may be forced to forcibly terminate the printing task during the printing process. This significantly reduces overall printing efficiency and print quality.

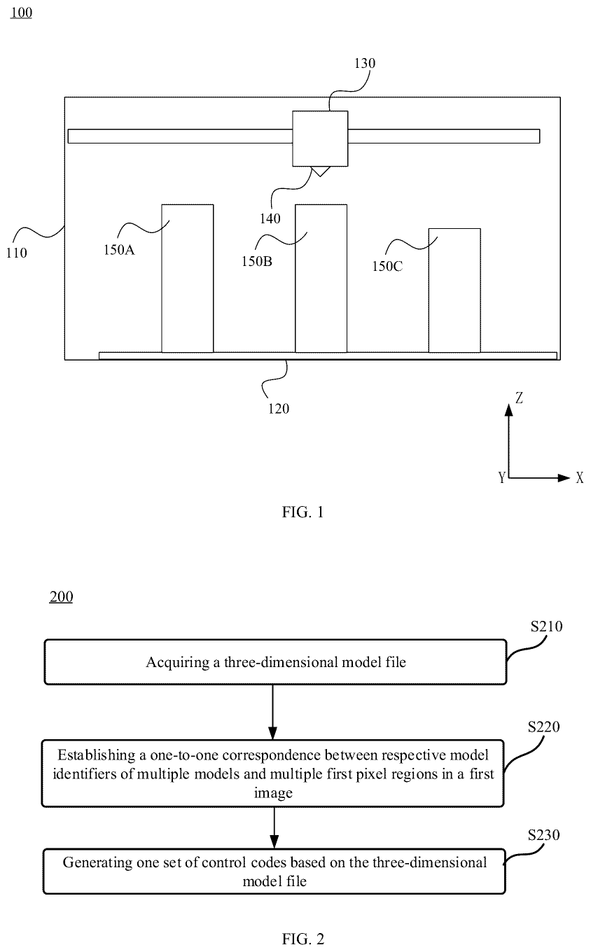

For example, FIG. 1 shows a structural schematic diagram of a 3D printer 100 according to the embodiments of the present disclosure. As shown in FIG. 1, the 3D printer 100 comprises a housing 110, a hot bed 120, a printing head 130, and a driving apparatus (not shown in FIG. 1). The 3D printer may also be provided with a lifting mechanism for driving the hot bed 120 to move up and down (i.e., along the Z-axis direction shown in FIG. 1). The driving apparatus is connected to the printing head 130 and is used to drive the printing head to move within the plane parallel to the hot bed 120 (i.e., the X-Y plane in FIG. 1). In an exemplary printing process, the hot bed 120 is raised to bring its upper surface close to a nozzle 140 of the printing head 130. The nozzle 140 extrudes melted printing filament, starting the printing of the first sliced layer of the model. After the first sliced layer is printed, the hot bed 120 descends by the height of the slice, and then the printing head 130 begins printing the second sliced layer on the upper surface of the first sliced layer. The above process is repeated in such a manner to complete the printing of multiple models (e.g., models 150A, 150B, and 150C). Assuming that, during the printing process, the model 150A fails to be printed due to the reasons mentioned above, the 3D printer 100 may still continue printing according to the established printing strategy in the G-code. That is, the nozzle 140 may continue extruding printing filament above the model 150A. However, since the model 150A is already damaged, continuing to extrude printing filament onto the model 150A would result in a waste of printing filament. Additionally, the extruded printing filament may hang from the nozzle 140, and the hanging printing filament may smear onto the model 150B or the model 150C as the printing head 130 moves, thus compromising the appearance and shape of the model 150B or the model 150C.

In view of this, the embodiments of the present disclosure provide a method and apparatus for a 3D printer, a 3D printer, a 3D printing system, a computer-readable storage medium, and a computer program product.

A further detailed explanation of the method for a 3D printer according to the embodiments of the present disclosure will be provided below with reference to FIG. 2. FIG. 2 shows a flowchart of a method 200 for a 3D printer according to the embodiments of the present disclosure. For descriptive purposes, FIG. 1 will also be concurrently referenced to describe the method 200, and the method 200 may be applied to the 3D printer 100 shown in FIG. 1. As shown in FIG. 2, the method 200 comprises:

step S210, acquiring a three-dimensional model file defining multiple models in a batch printing task;

step S220, establishing a one-to-one correspondence between the respective model identifiers of the multiple models and multiple first pixel regions in a first image, wherein the first image is used to display the respective graphical representations of the multiple models in a user interface, and each first pixel region is used to display a corresponding graphical representation in the respective graphical representations of the multiple models; and

step S230, generating, based on the three-dimensional model file, one set of control codes comprising multiple code segments, each code segment comprising control codes for printing a corresponding model in the multiple models and the model identifier of the corresponding model, wherein the one set of control codes is executable by a processor of the 3D printer to enable the 3D printer to execute a printing strategy.

The above-mentioned printing strategy comprises: skipping, in response to acquiring a control instruction to skip printing the target model in the multiple models, the execution of control codes within at least one code segment among the multiple code segments. The control instruction comprises the model identifier of the target model, and each code segment within the at least one code segment comprises the model identifier of the target model. Here, the control instruction is generated based on the selection operation of a user regarding the graphical representation of the target model on the first image through the user interface and the one-to-one correspondence.

In step S210, the three-dimensional model file may comprise model data for the multiple models (e.g., the models 150A, 150B, and 150C as shown in FIG. 1) in the batch printing task.

In step S220, the respective model identifiers of the multiple models may be the respective model IDs of the multiple models (e.g., the respective model IDs of the multiple models maybe 1,2, 3, etc.). Additionally, the first image may be a three-dimensional image capable of displaying the respective graphical representations of the multiple models in the user interface. The first image may comprise multiple (e.g., three) first pixel regions, and each first pixel region may correspond to the model ID of each model (e.g., 1, 2, and 3). The user may select the corresponding model through the graphical representation of each model displayed in the user interface. For example, if a user detects damage or error during the printing process of a certain model, the user may select the graphical representation of the damaged model in the user interface to trigger a control instruction to skip printing the damaged model.

In step S230, each code segment in the one set of control codes (e.g., G-code) may comprise multiple lines of code. Additionally, one code segment may be a code segment used to print one layer of a model during layer-by-layer printing; or one code segment may be a code segment used to print a complete model during piece-by-piece printing.

According to the method 200, each code segment in the generated one set of control codes comprises the model identifier of the corresponding model, and therefore, during the execution of the set of control codes by the 3D printer, when the control instruction to skip printing the target model in the multiple models is acquired, as the control instruction comprises the model identifier of the target model, the code segments including the model identifier corresponding to the target model may be skipped based on the model identifiers included in each code segment. Consequently, the 3D printer no longer executes printing operations regarding the target model. Thus, when the user triggers the control instruction to skip printing the damaged model, the 3D printer can promptly cease printing operations regarding the damaged model. This can save printing material on one hand, and on the other hand, it can reduce or prevent the excess extruded printing material from smearing onto other printing parts on the hot bed, thus protecting the appearance and shape of other printed parts.

According to some embodiments, the first image may be a virtual image of the multiple models generated for the batch printing task based on the three-dimensional model file. For example, the virtual image may be a color rendering image in RGB format generated through computer graphics (CG), allowing each model to have a colored appearance. The RGB values of the colors used for rendering may be determined based on the actual colors expected for the model in the printing task. In the virtual image, the graphical representation of the model to be printed may match the appearance of the corresponding real part of the model to be printed. Using a virtual image for the graphical representation of multiple models can help the user accurately position multiple models in the image, reducing the use difficulty for users and thus enhancing user experience.

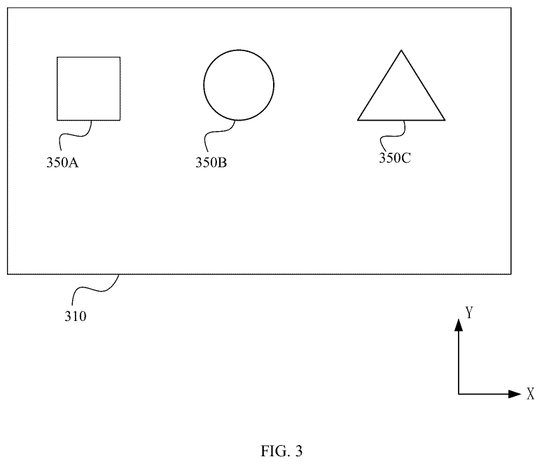

According to some embodiments, the first image may be a top view of the respective graphical representations of the multiple models. FIG. 3 shows a schematic diagram of a first image in the method for a 3D printer according to the embodiments of the present disclosure. As shown in FIG. 3, a first image 310 shows a top view of the three models (the models 150A, 150B, and 150C) from FIG. 1 on the XY plane. In the top view, the graphical representations of the models 150A, 150B, and 150C are respectively represented as graphical representations 350A, 350B, and 350C. By displaying the respective graphical representations of the top views of the multiple models in the user interface, the user can accurately correlate the graphical representations on the interface with the actual printed objects.

In some examples, the first image may be a color top view of the respective graphical representations of the multiple models.

According to some embodiments, the first image may be a real image of the actual printed objects corresponding to the multiple models, captured by a camera arranged at the 3D printer. Here, each actual printed object's pixel representation in the real image is the graphical representation of the corresponding model. The camera may be arranged relative to the 3D printer to capture the real image with a predetermined orientation, so that the relative positions of the multiple first pixel regions for the batch printing task in the first image are predetermined.

The camera (not shown in the figure) may be arranged at a predetermined position on the 3D printer, for example, it may be arranged on the top of the housing 110 and aimed at the hot bed 120 for capturing images, so that real images of the actual printed objects corresponding to the multiple models can be captured. It will be understood that the relative positions of the multiple first pixel regions displaying the actual printed objects in the real image may be known to the slicing software. This is because the slicing software has specified the layout (e.g., position and orientation) of the multiple models on the hot bed when slicing these models, and the resulting G-code will control the 3D printer to print these models on the hot bed according to the layout specified by the slicing software. Moreover, since the camera is installed at the predetermined position on the 3D printer, by calibrating the extrinsic parameters of the camera, the rotation and translation of the camera relative to the hot bed can be determined in advance. This allows the relative positions of the actual printed objects in the real image captured by the camera to reflect the layout of the multiple models on the hot bed. Therefore, before the actual printing process occurs, the relative positions of the multiple first pixel regions displaying the actual printed objects in the real image are predetermined, that is, they are known to the slicing software. This allows the slicing software to associate the respective model identifiers of the multiple models with the corresponding multiple first pixel regions, establishing a one-to-one correspondence. In one example, the camera may be oriented to capture a top view relative to the hot bed, thereby capturing a real top view of the actual printed object. The top view may serve as the first image displayed in the user interface.

According to some embodiments, the user interface may be the user interface for at least one of the following: the 3D printer, slicing software for 3D printing, or a mobile electronic device in communication connection to the 3D printer. Thus, in different usage scenarios, the user can observe the first image displayed on the user interface.

According to some embodiments, the control instruction may be generated by at least one of the following: the 3D printer, slicing software for 3D printing, or a mobile electronic device in communication connection to the 3D printer.

In one example, the user may click on the user interface on the 3D printer to select the target model that needs to be skipped during printing execution. In another example, the user may also click on the user interface of the slicing software for 3D printing to select the target model that needs to be skipped during printing execution. In another example, the user may also click on the user interface of the mobile electronic device (e.g., a mobile phone) in communication connection to the 3D printer to select the target model that needs to be skipped during printing execution.

After receiving the user's selection operation on the user interface, the 3D printer, the slicing software for 3D printing, or the mobile electronic device in communication connection to the 3D printer may learn the target model that needs to be skipped during printing execution based on the one-to-one correspondence between the selected first pixel region in the first image by the user and the model identifier of the corresponding model. Thus, it can provide various user interfaces for the user to select the target model that needs to be skipped during printing execution, thereby further enhancing the usage experience of users when promptly ceasing printing operations regarding the damaged model.

According to some embodiments, step S220 may comprise: creating a data structure. The data structure maps each first pixel region to the model identifier of a corresponding model in the multiple models, and the first pixel region is used to display the graphical representation of the corresponding model.

The data structure may be a lookup table or other index table. The data structure may store the mapping between each first pixel region and the model identifier of the corresponding model, so that when the user selects the first pixel region, the model identifier corresponding to the first pixel region selected by the user can be found through the data structure. This enables the 3D printer to skip executing the code segment corresponding to the model identifier.

According to some embodiments, the data structure may comprise a second image comprising multiple second pixel regions. The pixel position in each first pixel region may be mapped to the pixel position in a corresponding second pixel region in the multiple second pixel regions. The pixel value of the pixels in the corresponding second pixel region is the model identifier of the corresponding model for the first pixel region.

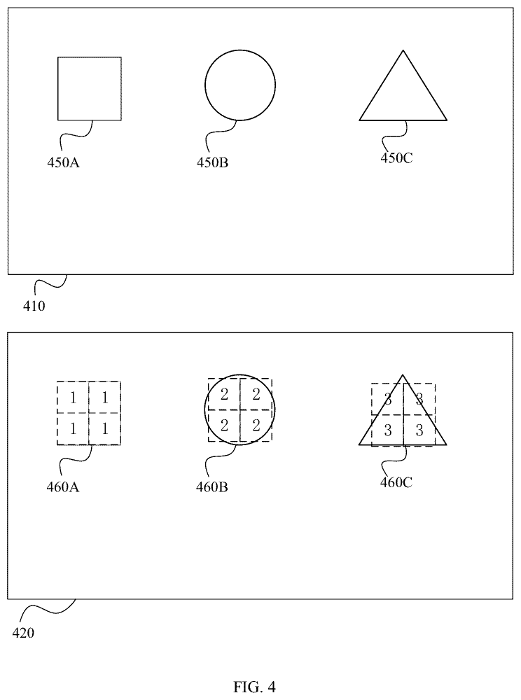

Referring to FIG. 4, FIG. 4 shows a schematic diagram of a first image and a second image in the method for a 3D printer according to the embodiments of the present disclosure. As shown in FIG. 4, the first image 410 may be similar to the first image 310 described in the previous section regarding FIG. 3. The second image 420 may comprise multiple second pixel regions (second pixel regions 460A, 460B, and 460C). From the first image 410 and the second image 420, it can be observed that the pixel position in each first pixel region may be mapped to the pixel position in a corresponding second pixel region in the multiple second pixel regions, and the pixel value of the pixels in the second pixel region 460A is the model identifier (model ID, 1) of the model corresponding to graphical representation 450A, the pixel value of the pixels in the second pixel region 460B is the model identifier (model ID, 2) of the model corresponding to graphic representation 450B, and the pixel value of the pixels in the second pixel region 460C is the model identifier (model ID, 3) of the model corresponding to graphic representation 450C. Thus, a corresponding model identifier may be incorporated into a code segment for printing the corresponding model in the multiple code segments. For example, the first code segment comprises the model identifier (model ID, 1), the second code segment comprises the model identifier (model ID, 2), and the third code segment comprises the model identifier (model ID, 3).

Thus, when the user selects a model (e.g., the model 150A) to skip printing from the first image 410 through the user interface, the printer can skip executing the code segment with the model ID 1, i.e., the aforementioned first code segment, through the mapping relationship between the graphical representation 450A in the first image 410 and the second pixel region 460A in the second image 420. As a result, the printing of the model 150A will no longer be executed in the printing task.

According to some embodiments, the resolution of the second image may be the same as that of the first image. In this case, the pixel positions in the multiple second pixel regions within the second image correspond one-to-one with the pixel positions in the multiple first pixel regions within the first image.

In one example, the resolution of the second image 420 and the resolution of the first image 410 may both be 1280*1280.

According to some embodiments, step S230 may comprise: adding the model identifier of the corresponding model respectively before and after the control codes in each code segment to delimit the control codes in the code segment.

For example, the one set of control codes may comprise 9 code segments, where the first, fourth, and seventh code segments are respectively used to print the first, second, and third layers of the model 150A; the second, fifth, and eighth code segments are respectively used to print the first, second, and third layers of the model 150B; and the third, sixth, and ninth code segments are respectively used to print the first, second, and third layers of the model 150C. The model identifier (e.g., model ID, 1) may be added before and after the first, fourth, and seventh code segments respectively; the model identifier (e.g., model ID, 2) may be added before and after the second, fifth, and eighth code segments respectively; and the model identifier (e.g., model ID, 3) may be added before and after the third, sixth, and ninth code segments respectively. Thus, when, for example, a control instruction to skip the model 150A is acquired, if the 3D printer is currently executing the fourth code segment and as the processor has already read the model ID (i.e., 1) before the fourth code segment, the 3D printer can immediately skip executing the fourth code segment and continue executing the fifth code segment, thereby continuing the printing of the model 150B. Further, when the processor reaches the seventh code segment, since the model ID before the seventh code segment is also 1, the 3D printer can skip executing the seventh code segment and continue executing the eighth code segment, thereby continuing the printing of the model 150B.

In some examples, each line of code in the code segment may include the corresponding model identifier before and after it, which is not further elaborated here.

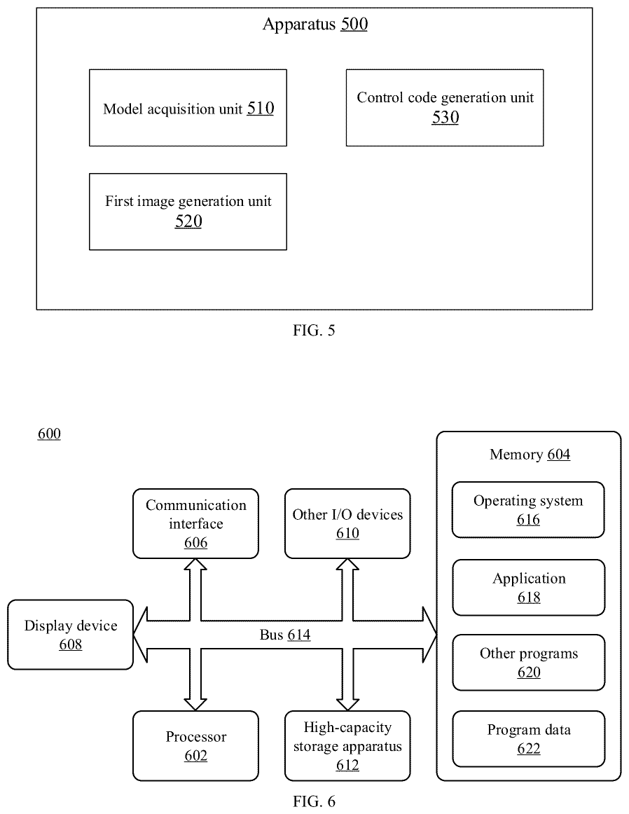

FIG. 5 shows a schematic block diagram of an apparatus 500 for a 3D printer according to the embodiments of the present disclosure. As shown in FIG. 5, the apparatus 500 comprises:

a model acquisition unit 510, configured to acquire a three-dimensional model file defining multiple models in a batch printing task;

a first image generation unit 520, configured to establish a one-to-one correspondence between the respective model identifiers of the multiple models and multiple first pixel regions in a first image, wherein the first image is used to display the respective graphical representations of the multiple models in a user interface, and each first pixel region is used to display a corresponding graphical representation in the respective graphical representations of the multiple models; and

a control code generation unit 530, configured to generate, based on the three-dimensional model file, one set of control codes comprising multiple code segments, each code segment comprising control codes for printing a corresponding model in the multiple models and the model identifier of the corresponding model, wherein the one set of control codes is executable by a processor of the 3D printer to enable the 3D printer to execute a printing strategy.

The printing strategy comprises: skipping, in response to acquiring a control instruction to skip printing a target model in the multiple models, the execution of control codes within at least one code segment among the multiple code segments. The control instruction comprises the model identifier of the target model, and each code segment within the at least one code segment comprises the model identifier of the target model. Here, the control instruction is generated based on the selection operation of a user regarding the graphical representation of the target model on the first image through the user interface and the one-to-one correspondence.

According to the embodiments of the present disclosure, a 3D printer is further provided, comprising a processor, and a memory storing one set of control codes generated using the method 200 described above. The one set of control codes is executable by the processor of the 3D printer to enable the 3D printer to execute the printing strategy.

According to yet another aspect of the present disclosure, a 3D printing system is further provided, comprising a 3D printer, and 3D printing slicing software configured to perform the method 200 described above.

According to yet another aspect of the present disclosure, a non-transitory computer-readable storage medium storing computer instructions is further provided. The computer instructions are used to cause the computer to perform the method 200 described above.

According to yet another aspect of the present disclosure, a computer program product comprising a computer program is further provided. The computer program, when run by a processor, causes the processor to implement the method 200 described above.

For brevity, details of the method 200 are not repeated.

In the following text, illustrative examples of such a computer device, non-transitory computer-readable storage medium, and computer program product are described in conjunction with FIG. 6.

FIG. 6 shows an exemplary configuration of a computer device 600 that can be used to implement the method described herein. For example, the aforementioned 3D printer may include an architecture similar to that of the computer device 600. The aforementioned 3D printer may also be fully or partially implemented by the computer device 600 or a similar device or system.

The computer device 600 may be various types of devices. Examples of the computer device 600 include, but are not limited to: desktop computers, server computers, laptop or netbook computers, mobile devices (e.g., tablets, cellular or other wireless phones (e.g., smartphones), notepad computers, mobile stations), wearable devices (e.g., glasses, watches), entertainment devices (e.g., entertainment consoles, set-top boxes communicatively coupled to display devices, gaming consoles), televisions or other display devices, automotive computers, and so on.

The computer device 600 may comprise at least one processor 602, a memory 604, (multiple) communication interfaces 606, a display device 608, other input/output (I/O) devices 610, and one or more high-capacity storage devices 612 capable of communicating with each other through, for example, a system bus 614 or other appropriate connections.

The processor 602 may be a single processing unit or multiple processing units, all of which may comprise one or more computing units or multiple cores. The processor 602 may be implemented as one or more microprocessors, microcomputers, microcontrollers, digital signal processors, central processing units, state machines, logic circuits, and/or any devices manipulating signals based on operational instructions. In addition to other capabilities, the processor 602 may be configured to acquire and execute computer-readable instructions stored in the memory 604, the high-capacity storage device 612, or the other computer-readable media, such as program code for an operating system 616, program code for applications 618, and program code for other programs 620.

The memory 604 and the high-capacity storage device 612 are examples of computer-readable storage media used to store instructions that the processor 602 executes to implement the various functions described earlier. For example, the memory 604 may generally comprise both volatile memory and non-volatile memory (e.g., RAM and ROM). In addition, the high-capacity storage device 612 may generally comprise hard disk drives, solid-state drives, removable media including external and removable drives, memory cards, flash memory, floppy disks, optical disks (e.g., CDs and DVDs), storage arrays, network-attached storage, storage area networks, and so on. The memory 604 and the high-capacity storage device 612 herein may both be collectively referred to as memory or computer-readable storage medium, and they may be non-transitory media capable of storing computer-readable, processor-executable program instructions as computer program code. The computer program code may be executed by the processor 602 serving as a particular machine configured to implement the operations and functions described in the examples herein.

Multiple programs may be stored on the high-capacity storage device 612. These programs comprise the operating system 616, one or more applications 618, other programs 620, and program data 622, and they may be loaded into the memory 604 for execution. Examples of such applications or program modules may comprise, for example, computer program logic (e.g., computer program code or instructions) for implementing the following components/functions: the acquisition unit 1010, the slicing unit 1020, the determination unit 1030, the methods 200, 300, 600, and 700, and/or additional embodiments described herein.

Although illustrated in FIG. 6 as stored in the memory 604 of the computer device 600, the modules 616, 618, 620, and 622, or portions thereof, may be implemented using any form of computer-readable media accessible by the computer device 600. As used herein, “computer-readable media” includes at least two types of computer-readable media, namely computer-readable storage media and communication media.

The computer-readable storage media include volatile and non-volatile, removable and non-removable media implemented through any method or technology for storing information, such as computer-readable instructions, data structures, program modules, or other data. The computer-readable storage media include, but are not limited to, RAM, ROM, EEPROM, flash memory, or other memory technologies, CD-ROMs, digital versatile discs (DVDs), or other optical storage apparatuses, magnetic cassettes, magnetic tapes, magnetic disk storage apparatuses, or other magnetic storage devices, or any other non-transmission media that may be used to store information for access by a computer device. In contrast, communication media may specifically implement computer-readable instructions, data structures, program modules, or other data in modulated data signals, such as carrier waves or other transmission mechanisms. The computer-readable storage media defined herein do not include communication media.

One or more communication interfaces 606 are used to exchange data with other devices, such as through networks and direct connections. Such communication interfaces may be one or more of the following: any type of network interface (e.g., network interface card (NIC)), wired or wireless (such as IEEE 802.11 wireless LAN (WLAN)) wireless interfaces, Worldwide Interoperability for Microwave Access (Wi-MAX) interfaces, Ethernet interfaces, Universal Serial Bus (USB) interfaces, cellular network interfaces, Bluetooth™ interfaces, Near Field Communication (NFC) interfaces, and so on. The communication interface 606 can facilitate communication within various network and protocol types, including wired networks (e.g., LANs and cables), wireless networks (e.g., WLANs, cellular, and satellites), the Internet, and so on. The communication interface 606 can also provide communication with external storage apparatuses (not shown) such as storage arrays, network-attached storage, and storage area networks.

In some examples, there may include a display device 608 such as a monitor for displaying information and images to a user. Other I/O devices 610 may be devices that receive various inputs from the user and provide various outputs to the user, and may comprise touch input devices, gesture input devices, cameras, keyboards, remote controls, mice, printers, audio input/output devices, and so on.

The techniques described herein may be supported by these various configurations of the computer device 600 and are not limited to specific examples described herein. For example, this functionality may also be implemented entirely or partially using a distributed system in the “cloud”. The cloud includes and/or represents platforms for resources. The platform abstracts the underlying functionality of the cloud's hardware (e.g., servers) and software resources. Resources may comprise applications and/or data that may be used when performing computational processing on servers distant from the computer device 600. Resources may further comprise services provided through the Internet and/or through subscriber networks such as cellular or Wi-Fi networks. The platform may abstract resources and functionalities to connect the computer device 600 with other computer devices. Therefore, the implementation of the functionality described herein may be distributed throughout the entire cloud. For example, the functionality may be implemented partially on the computer device 600 and partially through the platform's abstraction of cloud functionalities.

It should be understood that the various forms of processes shown above may be reordered, augmented, or reduced in steps. For example, the steps disclosed herein may be performed in parallel, sequentially, or in a different order, as long as the desired results of the technical solutions disclosed herein can be achieved. This document does not impose limitations in this regard.

While the embodiments or examples of the present disclosure have been described with reference to the accompanying drawings, it should be understood that the methods, systems, and devices described above are merely illustrative embodiments or examples. The scope of the present disclosure is not limited by these embodiments or examples, but rather is defined only by the claims as granted and equivalents thereof. Various elements in the embodiments or examples may be omitted or replaced by equivalent elements thereof. In addition, the steps may be performed in an order different from that described in the present disclosure. Further, the elements in the embodiments or examples may be combined in various ways. It is important to note that as technology evolves, many of the elements described herein may be replaced by equivalent elements that appear after the present disclosure.

What is claimed is:

1. A 3D printer, comprising:
a processor, and
a memory storing one set of control codes, wherein the one set of control codes is generated based on a three-dimensional model file defining multiple models in a batch printing task, and there is a one-to-one correspondence between respective model identifiers of the multiple models and multiple first pixel regions in a first image, wherein the first image is used to display respective graphical representations of the multiple models in a user interface, and each first pixel region is used to display a corresponding graphical representation in the respective graphical representations of the multiple models; and
wherein the one set of control codes comprises multiple code segments, each code segment comprising control codes for printing a corresponding model in the multiple models and a model identifier of the corresponding model, and the one set of control codes is executable by the processor of the 3D printer to enable the 3D printer to execute a printing strategy, the printing strategy comprising:
skipping, in response to acquiring a control instruction to skip printing a target model in the multiple models, execution of control codes within at least one code segment among the multiple code segments, the control instruction comprising a model identifier of the target model, and the at least one code segment comprising the model identifier of the target model, wherein the control instruction is generated based on a selection operation of a user regarding a graphical representation of the target model on the first image through the user interface and the one-to-one correspondence.

2. The 3D printer according to claim 1, wherein there exists, respectively before and after the control codes in each code segment, the model identifier of the corresponding model to delimit the control codes in the code segment.

3. The 3D printer according to claim 1, wherein the one-to-one correspondence between the respective model identifiers of the multiple models and the multiple first pixel regions in the first image is represented by a data structure, wherein the data structure maps each first pixel region to a model identifier of a corresponding model in the multiple models, and the first pixel region is used to display a graphical representation of the corresponding model.

4. The 3D printer according to claim 3, wherein the data structure comprises a second image comprising multiple second pixel regions, a pixel position in each first pixel region is mapped to a pixel position in a corresponding second pixel region in the multiple second pixel regions, and a pixel value of pixels in the corresponding second pixel region is the model identifier of the corresponding model for the first pixel region.

5. The 3D printer according to claim 4, wherein resolution of the second image is the same as resolution of the first image, and wherein pixel positions in the multiple second pixel regions within the second image correspond one-to-one with pixel positions in the multiple first pixel regions within the first image.

6. The 3D printer according to claim 1, wherein the first image is a virtual image of the multiple models generated for the batch printing task based on the three-dimensional model file.

7. The 3D printer according to claim 1, wherein the first image is a real image of actual printed objects corresponding to the multiple models, captured by a camera arranged at the 3D printer, and the camera is arranged relative to the 3D printer to capture the real image with a predetermined orientation, so that relative positions of the multiple first pixel regions for the batch printing task in the first image are predetermined.

8. The 3D printer according to claim 1, wherein the first image is a top view of the respective graphical representations of the multiple models.

9. The 3D printer according to claim 1, wherein the user interface is a user interface for at least one of the following:
the 3D printer, slicing software for 3D printing, or a mobile electronic device in communication connection to the 3D printer.

10. The 3D printer according to claim 1, wherein the control instruction is generated by at least one of the following:
the 3D printer, the slicing software for 3D printing, or the mobile electronic device in communication connection to the 3D printer.

11. A method, comprising:
acquiring one set of control codes, wherein the one set of control codes is generated based on a three-dimensional model file defining multiple models in a batch printing task, and there is a one-to-one correspondence between respective model identifiers of the multiple models and multiple first pixel regions in a first image, wherein the first image is used to display respective graphical representations of the multiple models in a user interface, and each first pixel region is used to display a corresponding graphical representation in the respective graphical representations of the multiple models; and
wherein the one set of control codes comprises multiple code segments, each code segment comprising control codes for printing a corresponding model in the multiple models and a model identifier of the corresponding model, and the one set of control codes is executable by the processor of a 3D printer to enable the 3D printer to execute a printing strategy, the printing strategy comprising:
skipping, in response to acquiring a control instruction to skip printing a target model in the multiple models, execution of control codes within at least one code segment among the multiple code segments, the control instruction comprising a model identifier of the target model, and the at least one code segment comprising the model identifier of the target model, wherein the control instruction is generated based on a selection operation of a user regarding a graphical representation of the target model on the first image through the user interface and the one-to-one correspondence.

12. The method of claim 11, wherein there exists, respectively before and after the control codes in each code segment, the model identifier of the corresponding model to delimit the control codes in the code segment.

13. The method of claim 11, wherein the one-to-one correspondence between the respective model identifiers of the multiple models and the multiple first pixel regions in the first image is represented by a data structure, wherein the data structure maps each first pixel region to a model identifier of a corresponding model in the multiple models, and the first pixel region is used to display a graphical representation of the corresponding model.

14. The method of claim 11, wherein the first image is a virtual image of the multiple models generated for the batch printing task based on the three-dimensional model file.

15. The method of claim 11, wherein the user interface is a user interface for at least one of the following:
the 3D printer, slicing software for 3D printing, or a mobile electronic device in communication connection to the 3D printer.

16. The method of claim 11, wherein the control instruction is generated by at least one of the following:
the 3D printer, the slicing software for 3D printing, or the mobile electronic device in communication connection to the 3D printer.

17. An apparatus for a 3D printer, comprising:
a model acquisition unit, configured to acquire a three-dimensional model file defining multiple models in a batch printing task;
a first image generation unit, configured to establish a one-to-one correspondence between respective model identifiers of the multiple models and multiple first pixel regions in a first image, wherein the first image is used to display respective graphical representations of the multiple models in a user interface, and each first pixel region is used to display a corresponding graphical representation in the respective graphical representations of the multiple models; and
a control code generation unit, configured to generate, based on the three-dimensional model file, one set of control codes comprising multiple code segments, each code segment comprising control codes for printing a corresponding model in the multiple models and a model identifier of the corresponding model, wherein the one set of control codes is executable by a processor of the 3D printer to enable the 3D printer to execute a printing strategy, the printing strategy comprising:
skipping, in response to acquiring a control instruction to skip printing a target model in the multiple models, execution of control codes within at least one code segment among the multiple code segments, the control instruction comprising a model identifier of the target model, and the at least one code segment comprising the model identifier of the target model, wherein the control instruction is generated based on a selection operation of a user regarding a graphical representation of the target model on the first image through the user interface and the one-to-one correspondence.

18. A 3D printing system, comprising:
a 3D printer; and
3D printing slicing software, configured to perform the method according to claim 11.

19. A non-transitory computer-readable storage medium storing computer instructions, wherein the computer instructions are used to cause a computer to perform the method according to claim 11.

20. A computer program product comprising a computer program, wherein the computer program, when run by a processor, causes the processor to implement the method according to claim 11.
